(19) United States
(12) Patent Application Publication
(10) Pub. No.: US 2018/0146784 A1
(43) Pub. Date: May 31, 2018

(54) Agglomerated Stone Countertop and Process of Manufacture

(71) Applicant: Chaobin HE, Warsaw (PL)

(72) Inventor: Chaobin HE, Warsaw (PL)

(21) Appl. No.: 15/447,925

(22) Filed: Mar. 2, 2017

(30) Foreign Application Priority Data
Nov. 29, 2016 (GB) 1620192.3

(51) Int. Cl. A47B 96/18; A47B 77/02; B28B 19/00; B32B 3/12; B32B 9/00

(52) U.S. Cl. CPC A47B 96/18; A47B 77/022; B32B 9/002; B28B 19/0046; B32B 3/12; B28B 19/0007

(57) ABSTRACT

The present invention provides a countertop (10) comprising a backer sheet (16) of a relatively lightweight, rigid material; an outer layer (14) of agglomerated stone disposed on a top surface (16a) of the backer sheet (16) to create a central portion (14a) of the countertop; and an outer layer (14) of agglomerated stone disposed on a side surface (16c, 16d) of the backer sheet (16) to create an edge portion (14b, 14c) of the countertop (10); wherein the central portion (14a) and edge portion(s)(14b, 14c) form a one piece agglomerated stone layer (14). The present invention also provides a moulding process to manufacture the agglomerated stone countertop (10).

### TECHNICAL FIELD

The present invention relates to an agglomerated stone countertop, particularly for use in kitchens and bathrooms, and a process for its manufacture.

### BACKGROUND

The term “agglomerated stone” is used to refer to a special class of composite stone slabs that contain very high (typically 90-94% by weight) stone content and very low (typically 6-10% by weight) resinous binder. It has become a common surfacing and countertop choice throughout the world and has many advantages over the natural stone material. Agglomerated stone is harder, more durable, and less porous than natural stone and is more resistant to staining, scratching, heat and chemicals. Agglomerated stone is also referred to as engineered stone, Bretonstone® or quartz.

A known process for the manufacture of an agglomerated stone slab comprises mixing together stone aggregates having a known grain size, a polyester resin and suitable additives, placing the mixture into a mould or tray, which has the dimensions of the required slab, pressing the mixture in the mould or tray by a so-called “vacuum vibro-compression” process (Breton S.p.A), curing the compressed mixture, and finally cutting and polishing, as desired, to provide the finished slab.

A standard slab of agglomerated stone typically has an area of approximately 4 square meters and a thickness of between 20 and 30 mm. The aesthetic appeal of a countertop is enhanced by the use of a thick slab, of at least 30 mm, with a correspondingly thick visible edge. However, even with a thickness of 20 mm, standard stone slabs are heavy, making them expensive to transport and difficult to handle and install. On the other hand, thinner stone slabs, of less than 20 mm, are susceptible to cracking and breakage.

To reduce the weight of a stone slab it is known to bond a backer sheet of a relatively lightweight yet rigid material, such as MDF, to an agglomerated stone slab having a thickness of less than 20 mm. In order to provide the slab thickness desired by the customer, a separate pre-cut stone edge piece is manually attached to the stone/backer sheet composite, thereby giving the impression that the whole countertop is of solid stone having the thickness of the edge. The known process has the disadvantage, however, that additional manufacturing and labouring steps are involved. In addition, by using a separate edge piece, an undesirable seam is visible.

### SUMMARY

It has now been found that a countertop of agglomerated stone that provides a solution to the above-mentioned problems may be manufactured by a novel moulding process.

Accordingly, a first aspect the present invention provides a countertop comprising: a backer sheet of a relatively lightweight, rigid material; an outer layer of agglomerated stone disposed on a top surface of the backer sheet to create a central portion of the countertop; and an outer layer of agglomerated stone disposed on a side surface of the backer sheet to create an edge portion of the countertop; wherein the central portion and edge portion form a one piece or continuous agglomerated stone layer.

The material of the backer sheet is relatively lightweight, which means that it weighs less than agglomerated stone of the same volume. The backer sheet is also exceptionally strong and rigid so as to securely and firmly support the agglomerated stone layer regardless of the size of the worktop.

Preferably, an embodiment of the first aspect of the invention is a countertop comprising:

a honeycomb backer sheet material having a top surface, a bottom surface and one or more side surfaces extending between the top and bottom surfaces;
a layer of agglomerated stone bonded to the top surface of the backer sheet defining a top portion of the countertop;
a layer of agglomerated stone bonded to at least one side surface of the backer sheet defining an edge portion of the countertop;
wherein the agglomerated stone covering the top surface and the at least one side surface of the backer sheet is a one-piece or continuous layer of agglomerated stone.

The edge portion of the countertop according to the present invention has a greater thickness than at central portions thereof and, as there are no seams or joints in the stone surface, the finished countertop has the appearance of solid stone. The weight of the countertop according to the invention, however, is significantly less than a corresponding stone countertop of the same thickness due to the relatively lightweight backer sheet replacing part of the heavier stone material.

In a second aspect the present invention provides a process for the manufacture of an agglomerated stone countertop, comprising the steps of:

providing a mould having a mould cavity defined therein, the mould cavity corresponding to a countertop, and including a bottom surface which corresponds to a top or a bottom surface of the countertop, and a side wall which corresponds to an edge surface of the countertop;
providing a backer sheet having a top surface, a bottom surface and side surfaces extending between the top and bottom surfaces;
providing an agglomerated stone composition;
disposing the backer sheet to partially fill the mould cavity in a spaced apart relationship with at least one side wall of the mould cavity and in the region of the mould cavity which corresponds to the area of the finished countertop having a reduced thickness of agglomerate stone;
disposing the agglomerated stone composition in the mould cavity;
wherein the space between the side surface of the backer sheet and the side wall of the mould is filled with agglomerated stone and the bottom or top surface of the backer sheet is covered with agglomerated stone; and
curing the stone composition.

In an embodiment of the process, the backer sheet member is preferably first disposed on the bottom surface of the mould cavity and the agglomerated stone composition is then disposed within the cavity over the backer sheet member and in the space defined between the backer sheet and the side wall. In this embodiment, the bottom surface of the mould cavity corresponds to a bottom surface of the countertop.

In an alternative embodiment of the process, the agglomerated stone composition is first disposed within the cavity so as to cover the bottom and side walls of the mould cavity, and the backer sheet member is then disposed in the mould cavity atop the agglomerated stone composition. Preferably, the process further comprises applying downward pressure to the backer sheet so that the top surface and at least one side surface of the backer sheet are embedded in the stone composition. In this embodiment, the bottom surface of the mould cavity corresponds to a top surface of the countertop.

The process according to the present invention may further comprise applying pressure and/or vibration to the contents of the mould. This forces the stone granules in the composition into a close-packed relationship. An example of an apparatus that is able to apply sufficient vibration and pressure to create close-packing of an agglomerated stone slab mixture is the Breton style press and copies thereof.

Preferably, the pressure and/or vibration is applied before or during the curing step.

Preferably, the backer sheet comprises a material having a honeycomb structure. The honeycomb backer sheet material may comprise a cell structure of vertically positioned tubes.

Preferably, the honeycomb backer sheet is made of a plastics material, such as poly(vinylchloride) (PVC), polyethylene and/or polypropylene.

Preferably, the honeycomb backer sheet includes a sheet of continuous material on its top surface, and optionally also on its side surfaces. This has the advantage that it provides a barrier to the seeping of agglomerated stone mixture into the cell structure in the manufacturing process. The continuous material is preferably the same as the material that forms the honeycomb structure. Preferably, the backer sheet comprises a honeycomb structure sandwiched between top and bottom continuous layers of the same material that is used to form the honeycomb structure.

Preferably, the backer sheet has a thickness of greater than about 10 mm, preferably a thickness of about 15 to about 40 mm, such as 20 mm, 25 mm or 30 mm.

Preferably, the layer of agglomerated stone covering the top surface of the backer sheet, or the layer of agglomerated stone which corresponds to the area of the finished countertop having a reduced thickness, has a thickness of less than about 20 mm, such as 15 mm, or less than about 10 mm, such as 8 mm.

The thickness of the agglomerated stone edge portion is preferably greater than about 20 mm, such as 30 mm, 35 mm or 40 mm. Preferably, the thickness of the agglomerated stone edge portion of the countertop corresponds to the combined thickness of the reduced thickness stone layer and the backer sheet.

The agglomerated stone in the countertop of the present invention generally comprises about 85 to about 97%, for example about 90 to about 95% or about 93 to about 96%, by weight, natural stone aggregates. The rest of the agglomerated stone composition comprises resin, pigments and additives. “Stone aggregates”, also referred to as stone granules, refers generically to particles of stone (typically quartz or silica based stone), or of other hard materials (such as glass, granite, marble and such like), having sizes in the range from about 0.2 mm up to about 20 to about 30 mm.

The term “resin” is used herein to refer to any resin and/or adhesive system capable of adhering together stone granules and quartz powder to form an agglomerated stone slab. Examples include epoxy, urethane, acrylic, vinyl ester, silicone resins, and even cementitious adhesives based on various forms of hydraulic type cements. When the resin is a polyester material, then it may include various additives that affect the cure rate, and especially the adhesion of the resin to silica and/or quartz based minerals and granites. In the quartz slab industry, the resin is, for economic reasons, typically a modified polyester thermosetting resin.

The dimensions of the mould cavity correspond in general to the dimensions of the finished slab or countertop. In one embodiment, the cured composition is trimmed/cut to size, preferably after it has been removed from the mould. Examples of preferred finished slab dimensions are: a width of about 58 to about 70 cm, or 60 cm, 62 cm or 65 cm, a depth of about 20 mm to about 50 mm, or 30 mm, 35 mm, 40 mm or 45 mm, and a length of about 3000 mm to about 4000 mm.

A protection layer may cover the exposed bottom surface of the backer sheet in the finished countertop.

In the process according to the invention, the step of curing the agglomerated stone composition may comprise subjecting the contents of the mould to a temperature of up to about 120° C., preferably a temperature of about 60° C. to about 80° C., more preferably about 70° C.

The backer sheet should be able to withstand the temperatures reached in the manufacturing process. The material used for the backer sheet is preferably a thermoplastic material having a melting point of greater than about 70° C., preferably from about 100° C. to about 260° C., more preferably from about 120° C. to about 200° C.

Preferably, the agglomerated stone composition is subjected to vibration and pressure prior to or during the curing step.

Preferably, the agglomerated stone composition is formed by blending natural stone aggregates with a binder under vacuum.

Preferably, the process according to the invention further comprises removing the cured slab from the mould and cutting the slab to the required size. The full thickness stone edge portion(s) of the cured slab may be trimmed as needed to provide a slab of the required size.

In the process described, the agglomerated stone layer becomes firmly adhered to the backer sheet without the need to apply a separate adhesive.

The countertop is preferably removed from the mould after it has cooled. If necessary, the countertop is then cut to size. The stone surfaces of the countertop may be sanded and/or polished, as required, to provide the finished article.

In a third aspect the present invention provides an agglomerated stone countertop produced by the method described.

An agglomerated stone countertop according to the present invention has a greater thickness proximate at least one edge thereof than it does at central portions thereof. In this way, the aesthetic appeal of the countertop is enhanced, while minimising weight and material employed in its manufacture. According to the process of the present invention, the edge portion is manufactured in a single step moulding process, wherein a backer member is disposed to partially fill the mould cavity in those regions which correspond to areas of the finished countertop having a reduced thickness. A backer material is suspended in the mould so as to fill a central portion thereof, while leaving edge portions unfilled. In this manner, when the agglomerated stone material forms a thinner layer in the areas of the backer material, but a full thickness layer proximate the edges. After curing of the agglomerated stone material, the backer material and the agglomerated stone material are bonded together and the finished article has the appearance of solid stone without joints.

Within the context of this disclosure, the term “countertop” shall refer to all panel-like bodies of material which may be prepared in accordance with the present invention and includes, but is not limited to, a kitchen worktop and a bathroom surface, a table top, a sill, a threshold, a mantle, a building panel and the like.

As used herein, the term “about” means the following:

In terms of percentage weight, plus or minus 1%; in terms of size, in mm, plus or minus 1 or 2 mm; and in terms of temperature, plus or minus 10° C.

Additional features and advantages of the present invention are described in, and will be apparent from, the description of the presently preferred embodiments which are set out below with reference to the drawings in which:

### BRIEF DESCRIPTION OF THE DRAWINGS

FIG. 1 shows a perspective view of an embodiment of a countertop according to the invention, with a section of the honeycomb backer sheet material removed;

FIG. 2 shows a perspective view of the honeycomb backer sheet material used in the countertop of FIG. 1;

FIG. 3 shows a side sectional view of an agglomerated stone composition in a mould according to a conventional process; and

FIG. 4 shows a side sectional view of an agglomerated stone composition in a mould according to the process of the invention.

### DETAILED DESCRIPTION

The process for manufacturing agglomerated stone countertops or slabs according to the present invention produces slabs having the appearance and performance characteristics that are equal or superior to solid slabs produced according to known methods. The slabs produced also weigh significantly less that the slabs manufactured according to the known method, thereby making them easier to transport and install, and cost less to manufacture.

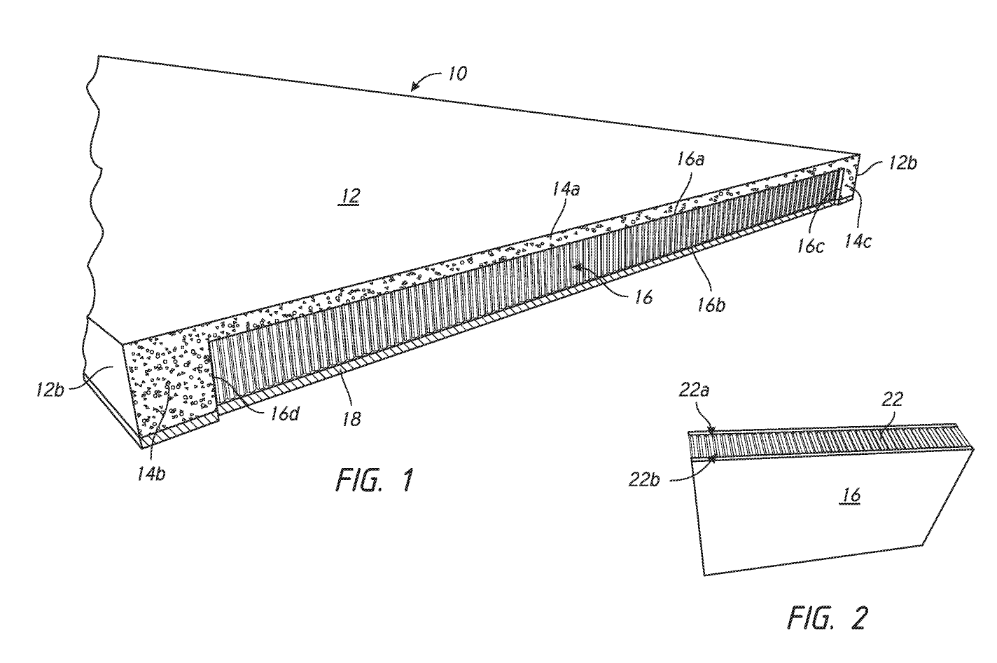

Referring to the Figures, in FIG. 1 a countertop (10) according to the invention has an outer surface (12) formed of a continuous layer (14) of agglomerated quartz made up of a central portion (14a) and edge portions (14b, 14c). The central portion has a thickness of 8-10 mm and the edge portions (14b, 14c) each have a thickness of 40 mm.

The quartz layer (14) of the countertop (10) is supported by a backer sheet material (16), which has a top surface (16a), a bottom surface (16b) and side surfaces (16c, 16d) extending between the top and bottom surfaces. The backer sheet (16) is fused at its top surface (16a) and side surfaces (16c) to the quartz layer (14). A protection layer (18) of 1 mm thickness is provided on the bottom surface (16b) of the backer sheet (16).

As illustrated in FIG. 2, the backer sheet material (16) consists of a honeycomb structure (22) sandwiched between continuous top (22a) and bottom (22b) layers. The sheet material (16) is of the sort which is readily available and comprises a plurality of cells, generally hexagonal or octagonal in cross-section. Such material is capable of withstanding high compression forces, especially when such forces are distributed over the face of the honeycomb structure. The honeycomb structure, including its top and bottom layers, is made of polyvinylchloride (PVC).

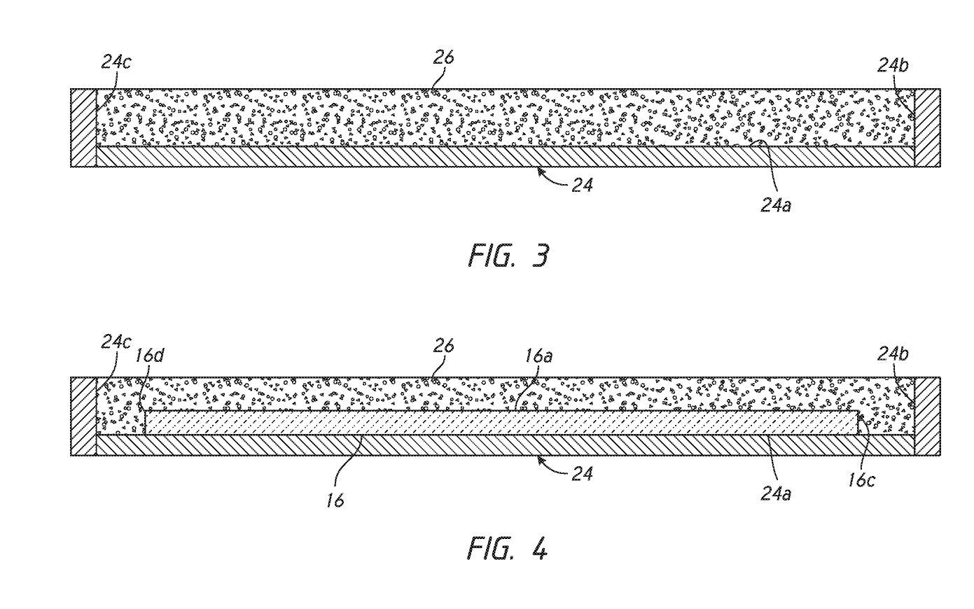

FIG. 3 illustrates a step in a conventional moulding process for the manufacture of an agglomerated stone countertop.

After the raw materials are weighed and measured, they are transported to a mixer and mixed together. The mixture (26) comprises 93% by weight quartz particulates and 7% by weight of a polymer resin ((66% quartz and 34% resin by volume) in combination with a bonding agent to promote the adhesion of the resin to the stone particulates and additives that include pigments and UV stabilizer. The mixed materials are then poured into a metal mould (24) or other suitable carrier that which can be used to transport the formed slab into a vacuum vibration press (VVP).

The mould (24) includes a cavity defined therein which corresponds to the slab or countertop (10) to be manufactured. The mould (24) has a flat bottom surface (24a) which corresponds to the top surface (12a) of the countertop and side walls (24b, 24c) which correspond to edges (12b) of the countertop (10). One standard mould cavity has a width of 60 cm, a depth of 40 mm and a length of 3040 mm.

The slab is then pressed by means of a vacuum vibration process. This process is well known and involves a pressing mechanism and vibration device being configured to apply compressional and vibrational forces to the slab to force the stone granules into a close-packed configuration in which there is sufficient resin and stone powder to fill all remaining voids between the stone granules. A vacuum vibration press of Breton S.p.A may be used. Alternatively, a vibration device may be provided above and optionally also below the slab in a vacuum chamber so that the stone composition is simultaneously compressed and vibrated under vacuum.

Once the slab has been pressed, it is transported to an oven or to some other location for curing. Depending upon the adhesive (resin) used to bind the particles together into the slab, the curing and hardening process can take place at ambient temperature or at elevated temperature, such as at 70 or 80° C., and can require from a few minutes up to many hours. The heating can be done by any available means of providing a heat source, such as radiant heat, forced-air heated ovens, electric ovens and the like. After curing and hardening, the slab is returned to room temperature (if heat has been applied). Alternatively, the cured slab is cooled by passive cooling, such as free convection, or by active cooling, such as cooling the mould with some cooling agent, such as air, water or other fluid.

The cured slab is then calibrated and polished to a desired finish. The result is a finished stone slab that is non-porous and closely approximates the appearance and physical properties of natural stone slabs.

As illustrated in FIG. 4, according to the process of the present invention, a honeycomb backer sheet (16) is first disposed on the bottom surface (24a) of the empty mould (24) cavity. The backer sheet (16) is disposed in a spaced apart relationship with the side walls (24b, 24c) of the mould (24) cavity so as to define respective spaces therebetween. The agglomerated stone mixture (26) is then poured into the mould (24) cavity over the honeycomb sheet material (16) and in the spaces defined between the honeycomb sheet material (16) and the side walls (24b, 24c). In this manner, the stone composition (26) will form a thinner layer (14a) in the areas of the backer sheet but a full thickness layer (14b, 14c) proximate the edges.

Once the backer sheet (16) and stone mixture (26) are disposed in the mould (24), the next steps of the process are pressing and curing as described above. When the contents (16, 26) of the mould (24) are heated to cure the stone mixture (26), the stone mixture becomes bonded to the adjacent sheet material (16). After cooling, the resulting moulded stone countertop (10) is removed from the mould (24) and has a smooth outer stone surface (12), including an integral built up edge of stone material. The continuous hardened stone layer (14) is about 8 to about 10 mm thick at its thinnest and about 40 mm thick at its thickest.

It is noted that while the process is described with reference to the manufacture of a rectangular countertop, other shapes such as squares, circles, ovals and the like can be made by the present invention.

It should be understood that various changes and modifications to the presently preferred embodiments described herein will be apparent to those skilled in the art. Such changes and modifications can be made without departing from the scope of the present invention and without diminishing its attendant advantages. It is therefore intended that such changes and modifications are covered by the appended claims.

1. A countertop (10) comprising: a backer sheet (16) of a relatively lightweight, rigid material; an outer layer of agglomerated stone (14) disposed on a top surface (16a) of the backer sheet (16) to create a central portion (14a) of the countertop; and an outer layer of agglomerated stone (14) disposed on a side surface (16c, 16d) of the backer sheet (16) to create an edge portion (14b, 14c) of the countertop (10); wherein the central portion (14a) and edge portion(s) (14b, 14c) form a one piece agglomerated stone layer (14).

2. A countertop (10) comprising:
a honeycomb backer sheet (16) having a top surface (16a), a bottom surface (16b) and one or more side surfaces (16c, 16d) extending between the top and bottom surfaces;
a layer of agglomerated stone bonded (14) to the top surface (16a) of the backer sheet (16) defining a top portion (14a) of the countertop (10);
a layer of agglomerated stone (14) bonded to at least one side surface (16c, 16d) of the backer sheet (16) defining an edge portion (14b, 14c) of the countertop (10);
wherein the agglomerated stone covering the top surface (14a) and the at least one side surface (14b, 14c) of the backer sheet (16) is a one-piece layer (14) of agglomerated stone.

3. A countertop according to claim 1, wherein the agglomerated stone comprises about 85 to about 98% by weight of stone aggregates.

4. A countertop according to claim 1 wherein the agglomerated stone comprises a resin as a binder.

5. A process for the manufacture of an agglomerated stone countertop (10), comprising the steps of:
providing a mould (24) having a mould cavity defined therein, the mould cavity corresponding to a countertop (10), and including a bottom surface (24a) which corresponds to a top (12a) or a bottom surface of the countertop (10), and a side wall (24b, 24c) which corresponds to an edge surface (12b) of the countertop;
providing a backer sheet (16) having a top surface (16a), a bottom surface (16b) and side surfaces (16c) extending between the top and bottom surfaces;
providing an agglomerated stone composition (26);
disposing the backer sheet (16) and the agglomerated stone composition (26) in the mould cavity such that the backer sheet (16) partially fills the mould cavity in a spaced apart relationship with at least one side wall (24b, 24c) of the mould cavity; and the agglomerated stone composition (26) fills the space between the side surfaces (16c, 16d) of the backer sheet (16) and the side wall (24b, 24c) of the mould cavity and covers the bottom or top surface (16a) of the backer sheet (16); and
curing the stone composition.

6. A process according to claim 5, wherein the backer sheet (16) is first disposed on the bottom surface (24a) of the mould cavity and the agglomerated stone composition (26) is subsequently disposed over the top surface (16a) of the backer sheet (16) and in the space defined between the side surfaces (16c, 16d) of the backer sheet (16) and the side walls (24b, 24c) of the mould cavity.

7. A process according to claim 6, further comprising applying pressure and/or vibration to the contents (16, 26) of the mould (24).

8. A process according to claim 7 further comprising trimming at least one edge (14b, 14c) of the layer (14) of cured stone composition (24).

9. A process according to claim 8 wherein the backer sheet (16) comprises a material of honeycomb structure.

10. A process according to claim 9, wherein the honeycomb structure comprises a plastics material.

11. A countertop according to claim 2, wherein the agglomerated stone comprises about 85 to about 98% by weight of stone aggregates.

12. A countertop according to claim 11 wherein the agglomerated stone comprises a resin as a binder.

13. A process according to claim 6 further comprising applying pressure and/or vibration to the contents (16, 26) of the mould (24).

14. A process according to claim 5, wherein the backer sheet (16) comprises a material of honeycomb structure.
